(19) United States
(12) Patent Application Publication
(10) Pub. No.: US 2018/0074344 A1
(43) Pub. Date: Mar. 15, 2018

(54) METHOD FOR GENERATING INFORMATION FOR ASSISTING LENS PRESCRIPTION

(71) Applicant: NIDEK CO., LTD., Gamagori-shi (JP)

(72) Inventor: Shirohisa KOBAYASHI, Nukata-gun (JP)

(73) Assignee: NIDEK CO., LTD., Gamagori-shi (JP)

(21) Appl. No.: 15/695,524

(22) Filed: Sep. 5, 2017

(30) Foreign Application Priority Data
Sep. 5, 2016 (JP) 2016-173215
Sep. 5, 2016 (JP) 2016-173216

(51) Int. Cl. G02C 7/02; G06T 11/60; G06F 17/50

(52) U.S. Cl. CPC G02C 7/027; G06F 17/5009; G06T 11/60

(57) ABSTRACT

A method of generating information for assisting lens prescription, the method including: an obtention step in which a computer obtains information related to examinee's eye characteristics, and correction simulation information, indicating vision of the examinee's eye assuming a correction lens prescription; and a display control step of generating a first report summarized with information related to the examinee's eye characteristics and used for the correction lens prescription, a second report at least including the correction simulation information, and a third report including an ocular model image and at least a part of the information related to the examinee's eye characteristics having influence on the vision in the correction simulation information, the part of the information being displayed associated with each ocular part in the ocular model image, the display control step controlling the computer to selectively display at least any one of the reports on a monitor.

### CROSS-REFERENCE TO RELATED APPLICATIONS

This application is based upon and claims the benefit of priorities from the prior Japanese Patent Applications No. 2016-173215, filed Sep. 5, 2016, and No. 2016-173216, filed Sep. 5, 2016, the entire contents of which are incorporated herein by reference.

### BACKGROUND

### Technical Field

The present disclosure relates to a method of generating information for assisting lens prescription, the information being used for assisting prescription of eyeglasses based on optometric results.

### Background

There have been known optometry devices configured to objectively measure information related to refractive power of an examinee's eye. Objective measurement results obtained by an optometry device is, for example, output and displayed on a monitor, and then utilized for prescription of a correction lens such as an eyeglass lens.

Patent Document 1 discloses a device providing information indicating an objective measurement result of the examinee's eye, the information being displayed in a form of an ocular model image representing an examinee's eyeball in correspondence with each part of the examinee's eye.

### RELATED ART DOCUMENTS

### Patent Documents

Patent Document 1: JP2015-144730A

### SUMMARY

### Technical Problems

However, information included only in the display of the ocular model image as described in Patent Document 1 has not been enough for an examiner to perform a subjective examination and prescribe a correction lens. The present inventors have thus made a study of a display method that can make an examiner and an examinee easily obtain useful information for performing the subjective examination and prescribing the correction lens.

The present inventors have further made a study of display that can help the examiner and the examinee to prescribe a lens with higher quality of vision in consideration with various conditions other than a refraction value even when correction lenses usually stocked in an eyeglass shop or the like are to be prescribed.

The present disclosure has been made in view of at least one of the above circumstances and has a purpose of providing a method of generating information for assisting lens prescription, achieving further favorable prescription of a correction lens.

### Means of Solving the Problems

To solve the above problem, the present disclosure has the following configuration. One configuration provides a method of generating information for assisting lens prescription, the method including: an obtention step in which a computer obtains information related to examinee's eye characteristics including refraction information about refraction of an entire examinee's eye, and correction simulation information, which is generated at least based on the refraction information, indicating vision of the examinee's eye assuming a correction lens prescription; and a display control step of generating a first report summarized with information related to the examinee's eye characteristics and used for the correction lens prescription, a second report at least including the correction simulation information, and a third report including an ocular model image and at least a part of the information related to the examinee's eye characteristics having influence on the vision in the correction simulation information, the part of the information being displayed associated with each ocular part in the ocular model image, the display control step controlling the computer to selectively display at least any one of the reports on a monitor.

Another configuration of the present disclosure to solve the above problem is a method of generating information for assisting lens prescription, the method including: an obtention step in which a computer obtains information related to examinee's eye characteristics including refraction information about refraction of an entire examinee's eye, and correction simulation information, which is generated at least based on the refraction information, indicating vision of the examinee's eye assuming a correction lens prescription; and a display control step of generating a first report summarized with the information related to the examinee's eye characteristics and used for the correction lens prescription, and a third report including the correction simulation information and an ocular model image, the third report being generated and displayed with at least a part of the information related to the examinee's eye characteristics having influence on vision in the correction simulation information, the part of the information being associated with each ocular part in the ocular model image, the display control step controlling the computer to selectively display at least any one of the reports on a monitor.

### BRIEF DESCRIPTION OF THE DRAWINGS

FIG. 1 is a schematic diagram of a lens prescription assisting apparatus in the present embodiment;

FIG. 2 is a flow chart showing operation of the apparatus when a lens prescription assisting program is carried out;

FIG. 3 is a display image of a basic information report in an example;

FIG. 4 is a display image of a simulation report in the example; and

FIG. 5 is a display image of an eye diagram image report in the example.

### DETAILED DESCRIPTION OF THE EXEMPLARY EMBODIMENTS

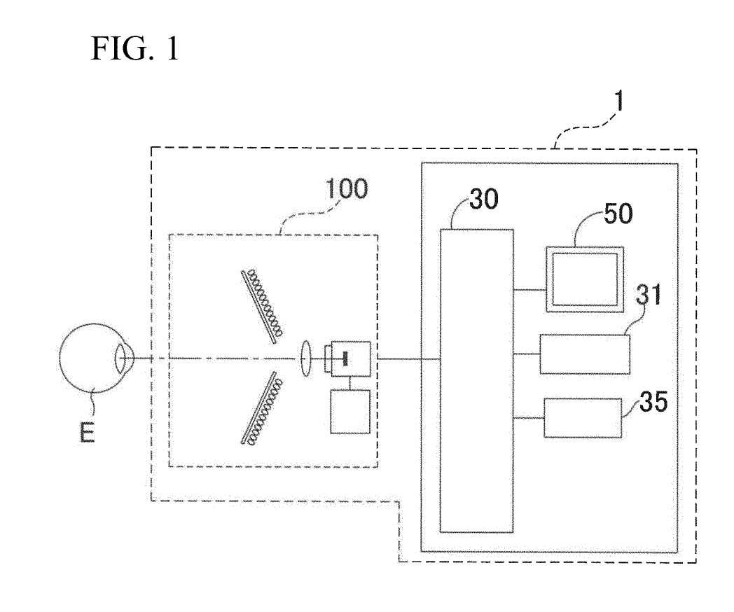

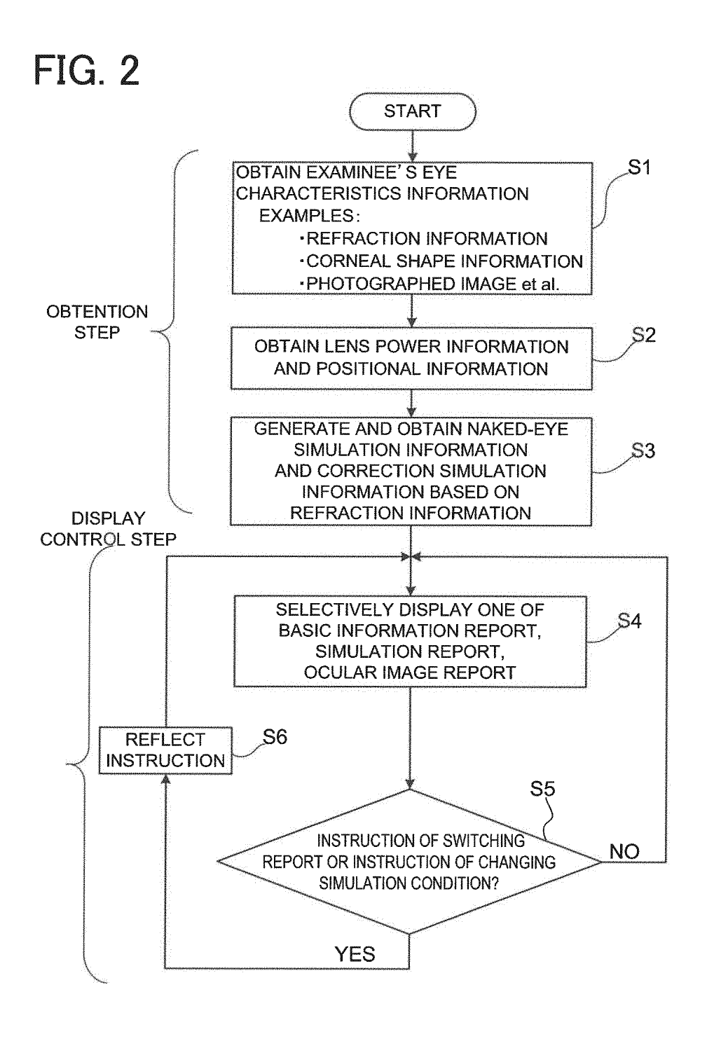

The present disclosure is now explained based on an embodiment below. An outline of a lens prescription assisting apparatus (hereinafter, referred to an “apparatus”) 1 according to the embodiment is firstly explained with reference to FIGS. 1 and 2. The apparatus 1 is a computer that executes a lens prescription assisting program of the present embodiment (see FIG. 2) by its processor.

The apparatus 1 executes the lens prescription assisting program so that useful information for lens prescription is presented to an examiner and an examinee by three types of reports. The three reports at least provide simulation information indicating vision of an examinee's eye and information indicating the examinee's eye characteristics. In the following explanation, the three reports are referred as a “basic information report,” a “simulation report,” and an “eye diagram image report” for convenience. The apparatus 1 may selectively display any one of these three reports on a monitor.

The foregoing explanation is given with an example that the apparatus 1 carries out displaying for prescribing an eyeglass lens as one type of correction lenses. The apparatus 1 is however not limited to this example and may be alternatively utilized for prescribing contact lenses.

The apparatus 1 at least includes a control part (processor of the apparatus 1) and a memory 31. The control part 30 is responsible for various arithmetic processing, control of each part, display control of various reports, and others.

The lens prescription assisting program may be stored in the memory 31 in advance in the present example. In another example, a detachable storage medium (such as a flash memory and an external hard disk, which are not shown) attached to the apparatus 1 may store the program instead of the memory 31.

The memory 31 may also store information related to the examinee's eye characteristics. Examples of the information related to the examinee's eye characteristics include various measurement results measured by the optometry device and various photographed results of the examinee's eye. The control part 30 displays these measurement results and the photographed results, or further processed results of these results in each report.

A monitor 50 displaying each report may be attached in advance to the apparatus 1 or may be separately provided.

The apparatus 1 may be separately provided from the optometry device or may be integrally configured. The apparatus 1 of the present example is integrally configured with a wavefront sensor as one example of the optometry device and includes a measurement optical system 100 to measure naked-eye wavefront aberration data (one of refraction information) of the examinee's eye. The naked-eye wavefront aberration data may be data indicating distribution of wavefront aberration (referred as wavefront aberration distribution data) of the examinee's eye. The apparatus 1 may be integrally configured with a subjective examination device. When the apparatus 1 is a separate apparatus, the apparatus 1 may be configured as a general-purpose computer such as a PC or a tablet terminal. In this case, the apparatus 1 may obtain various information (including obtention of simulation information indicating vision of the examinee's eye, information indicating the examinee's eye characteristics, and others which will be described later) directly from the optometry device or may obtain through other devices that are connected via network.

Further, the apparatus 1 may be a server (for example, a cloud server) connected via network with the optometry device and a client server which is placed in an eyeglass shop.

The measurement optical system 100 may be any one of a phase-differential-type wavefront sensor (a skiascopic wavefront sensor), a wavefront sensor using a Shack-Hartmann wavefront sensor, and a Talbott wavefront sensor (for details, see JP2006-149871A filed by the present applicant). The phase-differential wavefront sensor is configured to project slit-like luminous flux on a fundus and then output a phase differential signal upon detecting the reflection luminous flux by a light receiving element (see JP10-108837A filed by the present applicant, for example).

The apparatus 1 of the present example includes a wavefront sensor using a phase differential signal as the measurement optical system 100. In this phase differential type, distribution data of refractivity of the examinee's eye (namely, a refractive error from a normal eye) is obtained as a processing result of the phase differential signal. This distribution data of the refractivity is converted into distribution data of the wavefront aberration. The distribution data of the wavefront aberration is one example of information related to refraction of the entire examinee's eye and is equivalent to data expressed in a form of refractive power (for example, distribution data of the refractivity).

The apparatus 1 may further include a corneal shape measurement optical system such as a keratometer or a topographer as the measurement optical system 100. The corneal shape measurement optical system may be configured such that a target beam such as a mire-ring or a placido ring is projected to photograph a target image formed on the cornea as an anterior segment front image, or may be configured to photograph sectional images of the cornea relative to a plurality of meridians. The control part 30 appropriately processes the anterior segment front image or plural corneal sectional images to obtain corneal shape data.

The apparatus 1 may further include an anterior segment camera (not shown) for photographing the anterior segment image including a pupil part of the examinee's eye. From the anterior segment image, a pupil size (diameter) of the examinee's eye can be measured, for example. This anterior segment camera may be configured to photograph by changing quantity of illumination light. Specifically, the anterior segment image of the examinee's eye may be photographed in each of photopic vision (in daytime) and twilight vision (in nighttime). In this case, the apparatus 1 may be configured to adjust illumination light source output to a first illumination light amount for photographing in the photopic vision and a second illumination light amount less than the first illumination light amount for photographing in the twilight vision. Furthermore, the apparatus 1 may be configured to photograph a transillumination image of the examinee's eye by use of the anterior segment camera.

As shown in a flow chart of FIG. 2, various information is gathered in the apparatus 1 (an obtention step) in advance of a process of displaying a report (a display control step). To be specific, information indicating the above-mentioned examinee's eye characteristics (S1), lens power information and lens positional information (S2), various simulation information (S3), and others are stored in the memory 31. Each report based on the thus stored information is displayed in the display control step. Detailed explanation of the lens positional information is given below.

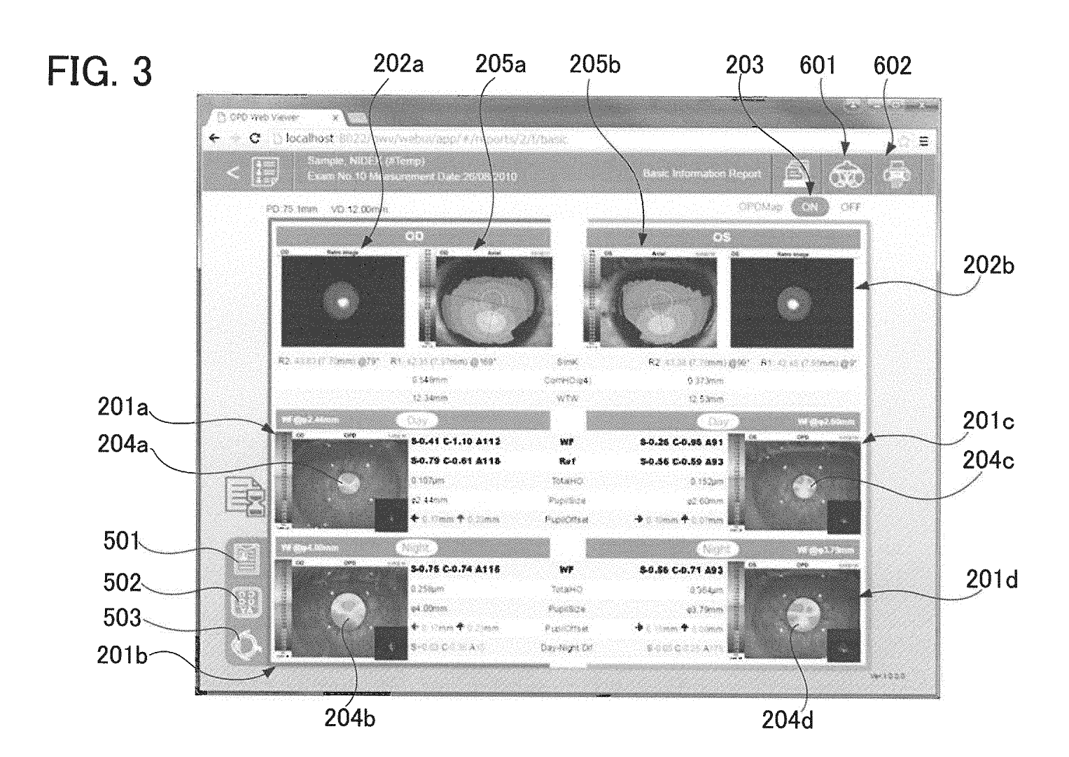

In the display control step, any one of the three reports (the basic information report, the simulation report, and the eye diagram image report) is selectively displayed on the monitor 50 by the control of the apparatus 1 (S4). In the present example, instruction of switching the reports and instruction of changing simulation conditions are allowed to be input properly to the apparatus 1 based on examiner's input operation. When the instruction is input (S5: YES), the apparatus 1 reflects this instruction on a report displayed on the monitor (S6). Contents of each instruction and specific examples of a method for inputting the instructions will be explained with each specific examples of the reports (FIGS. 3 to 5).

The three reports (the basic information report, the simulation report, and the eye diagram image report) which are displayed on the monitor 50 by the apparatus 1 are explained in detail with reference to FIGS. 3 to 5. As mentioned above, any one of the three reports is selectively displayed on the monitor 50 in the present example.

Each report includes various information. Specifically, each report includes any one of the simulation information indicating vision of the examinee's eye, information indicating the examinee's eye characteristics, and others.

The information indicating the examinee's eye characteristics at least includes a measurement result of the examinee's eye measured by the optometry device and indicating characteristics of an ocular optical system. The information may further include a photographed image of the examinee's eye indicating the characteristics of the ocular optical system. Specific examples of the measurement result of the examinee's eye measured by the optometry device include information related to refraction of the entire examinee's eye and information related to the corneal shape.

Further, the information related to refraction of the entire examinee's eye may include the aforementioned wavefront aberration distribution data of the examinee's eye (the data may be in a form of the distribution data of refractive power). This information related to the wavefront aberration distribution data may be shown as a two-dimensional map or may be represented in numerical values. In the basic information report, the two-dimensional map and the numerical values related to that map (namely, numerical values related to the examinee's eye aberration) are associated to each other and shown. These numerical values may be calculated based on the wavefront aberration distribution data corresponding to each point on the pupil. The numerical values may be expressed in a form of the refractive power (including a case of refractive error). For example, the values may be each one of S (spherical power), C (cylindrical power), and A (astigmatic axis angle) which are considered the wavefront aberration distribution data corresponding to each point on the pupil. Alternatively, the values may be the ones obtained by digitizing high-order aberration components of the entire examinee's eye.

Refraction information of the entire examinee's eye which is indicated in each report in the apparatus 1 is information obtained at least by far-point measurement. Other than that, the apparatus 1 may obtain the refraction information of the entire examinee's eye through measurement in a state in which the examinee's eye is subjected to accommodation load and may display the refraction information under the accommodation load in each report. Furthermore, the apparatus 1 may generate simulation information based on the refraction information under the accommodation load (which will be explained in detail below) and this simulation information may be displayed concurrently or one at a time with another simulation information based on the refraction information at the far-point measurement in either report.

Information related to the corneal shape includes at least any one of curvature information of a corneal surface, elevation information of the corneal surface (a height difference in an approximate spherical surface of the cornea), information related to refraction distribution on the cornea, sectional shape information of the cornea, and others. The information may be indicated in a two-dimensional map or represented as numerical values.

The simulation information graphically indicates vision of the examinee's eye that is assumed based on the refraction information of the entire examinee's eye. The simulation information may be information indicating the vision of a naked eye or may be information indicating the vision in a corrected state.

The simulation information is, for example, generated based on information related to refraction of the entire examinee's eye. Specified examples of the simulation information may include a simulation image of an optotype image formed on a fundus surface and a figure or a graph indicating a simulation result of changes in vision (“changes in vision” may be “changes in quality of vision”) of the examinee's eye when some conditions are changed. The simulation image of the optotype image may be an image representing a point spread function (PSF) on the fundus surface or may be an image representing an appearance of a subjective examination target.

In each report, information that changes between the daytime and the nighttime may be displayed with the information both in the daytime and the nighttime at the same time. Alternatively, any one of the information in the daytime and the information in the nighttime may be selectively displayed. In this case, the information in the daytime and the information in the nighttime may be switched to be displayed based on a predetermined input operation. Displaying both the information in the daytime and the nighttime makes it easy for the examiner or the examinee to realize differences in an eye state that changes in the daytime and the nighttime. Accordingly, when the difference in the state of the eye is large between the daytime and the nighttime, the above display is useful for the examiner to propose a prescription of eyeglasses for nighttime use to the examinee.

Between the daytime and the nighttime, a pupil size changes, and information related to the refraction of the entire examinee's eye also changes due to the changes in the pupil size. Examples of information that changes in the daytime and the nighttime include the simulation information and the anterior segment image other than the information related to the pupil size and the refraction of the entire examinee's eye.

In each report, each information of left and right eyes may be concurrently displayed. In this case, the information related to the right eye and the information related to the left eye may be arranged in left and right parts on a screen, respectively.

Further, the apparatus 1 may indicate the positional information of the eyeglass lens in any one of the reports.

The positional information of the eyeglass lens is information related to a position where the eyeglass lens is placed with respect to the examinee's eye or an examinee's face. Specified examples of the positional information include a PD (a pupillary distance: an interval between left and right eyes) and a VD (a vertex distance: a distance between a corneal apex and a back surface of the eyeglass lens). Each positional information may be an actual measured value.

<Basic Information Report>

Of the three reports, the basic information report is firstly explained. The basic information report is mainly configured with two or more types of ocular optical system information. The basic information report preferably includes summarized information which is to be provided to the examiner. To be more specific, the basic information report is preferably summarized with at least several information of the examinee's eye characteristics information that is used for lens prescription. Further, in the present embodiment, the basic information report is summarized with the positional information of the eyeglass lens.

The basic information report preferably includes at least information related to the refraction of the entire examinee's eye as the examinee's eye characteristics information. The examinee's eye characteristics information may further include information about the corneal shape, anterior segment front images 201a to 201d of the examinee's eye, transillumination images 202a and 202b, a pupil size, and others.

The basic information report shown in FIG. 3 is displayed with refractivity distribution maps 204a to 204d of the examinee's eye as one refraction information of the examinee's eye. These maps indicate the refractivity (a refraction error) in each point on the pupil. As shown in FIG. 3, the refractivity distribution maps 204a to 204d are superimposed and displayed on the pupil in the anterior segment front images 201a to 201d. In the present example, the refractivity distribution maps 204a to 204d are introduced as processing results of phase differential signals that are output from the measurement optical system 100. In the present example, the refractivity distribution maps 204a to 204d are displayed according to choosing operation of a button 203. The refractivity distribution maps 204a to 204d make the examiner acknowledge whether the examinee's eye is easily improved its vision by prescribing a correction lens.

In FIG. 3, the report displays each value of S, C, and A (“WF refraction values” in FIG. 3) based on the wavefront aberration distribution data corresponding to each point on the pupil, each value displayed in association with the refractivity distribution maps 204a to 204d, and further displays values indicating the high-order aberration components. The WF refraction values are available as initial values of the subjective examination. Further, when the high-order aberration value is large, the examiner can understand that an accommodation power is hardly improved even by correcting with the eyeglass lens. The WF refraction values and the high-order aberration values are not necessarily displayed both at the same time, and either one may be displayed.

In FIG. 3, “refraction values” are also displayed associated with the refractivity distribution maps 204a to 204d. The “refraction values” of the present examples are represented as values S, C, and A each indicating the refractivity (the refraction error) in a partial region (specifically, a ring-like region having a predetermined radius) on the pupil. The “refraction value” is derived by obtaining the refractivity from the phase differential signal in the ring-like region having the predetermined radius. In the present example, the “refraction value” is a reference value. The WF refraction value is closer to the final prescription value than the refraction value since the WF refraction value is considered with aberration in each point of the examinee's eye.

Further, in FIG. 3, a pupil size and a pupil offset are indicated in association with the anterior segment front images 201a to 201d. The pupil offset represents a deviation amount between a measurement axis and a pupil center. The pupil offset value is, for example, utilized for correcting the pupillary distance PD.

The pupil size differs in the daytime and the nighttime, and according to this change in the pupil size, the refraction information of the entire examinee's eye also changes. Accordingly, the information related to refraction of the entire examinee's eye displayed in the basic information report includes the information in the daytime and the information in the nighttime both displayed at the same time. In this case, the information in the daytime and the nighttime may be separately displayed in different areas on the screen. As one example, the information about refraction of the entire examinee's eye in the daytime and the information about refraction of the entire examinee's eye in the nighttime are separately displayed in upper and lower parts on the screen in FIG. 3.

The display in the present example further includes the difference in the WF refraction values (each value S, C, and A which is considered with the wavefront aberration distribution data corresponding to each point on the pupil) between the daytime and the nighttime. When there is a large difference from the examinee's eye that has been corrected on the basis of the refractivity in the daytime, the vision in the nighttime is considered to be low by the thus determined corrected value. In the present example, the above difference is displayed in association with the nighttime refractivity distribution maps 204b and 204d.

The basic information report shown in FIG. 3 includes display of a corneal curvature, aberration in the cornea, dimensions of the cornea (a diameter or a radius), corneal curvature maps 205a and 205b, and others as information related to the corneal shape. In FIG. 3, these information is gathered and displayed in the upper part on the screen.

In FIG. 3, a corneal principal meridian is superimposed and displayed on each of the corneal curvature maps 205a and 205b. The corneal curvature is made use for prescribing a contact lens, for example. The corneal curvature maps make the examiner easily notify possibility of abnormal corneal shape such as keratoconus. The corneal curvature maps 205a and 205b are further useful for the examiner to conclude whether the astigmatic components in the refraction value are originated by the cornea. The basic information report in FIG. 3 includes display of the transillumination images 202a and 202b. When cloudiness or opacity is confirmed in the transillumination images 202a and 202b, the examiner can easily understand that the visual acuity is hardly improved due to the opacity even if correction by an eyeglass lens is made. In FIG. 3, the transillumination images 202a and 202b are gathered and displayed in the upper part of the screen.

In FIG. 3, the information related to the corneal shape, the transillumination images 202a and 202b are each displayed with an amount of components that cannot be corrected by prescription of the correction lens, the amount being represented as numerical values or images. Based on this information, the examiner can conclude whether the examinee's eye is the one easy to be improved its vision by prescribing the correction lens.

Especially in FIG. 3, the information related to the corneal shape and the transillumination images 202a and 202b are displayed separately from the information related to refraction of the entire examinee's eye (displayed in different areas). Accordingly, the examiner can easily distinguish the information related to refraction of the entire examinee's eye, that is to be directly utilized for the prescription of the eyeglass and the subjective examination, from reference information supporting the subjective examination and others (for example, the information related to the corneal shape and the tarnsillumination images 202a and 202b).

Further, in FIG. 3, the information related to the corneal shape and the transillumination images 202a and 202b are displayed adjacent to one another. Thus, the examiner can further easily conclude whether the examinee's eye is easy to be improved its vision by prescribing the correction lens.

Further, in the basic information report in FIG. 3, the information related to the characteristics of both the left and right examinee's eyes are concurrently displayed. To be specific, the information related to the examinee's eye characteristics of each of the left and right eyes is displayed separately in left and right parts on the screen. Thus, the examiner can easily conclude whether the examinee's eye suffers from anisometropia.

The basic information report in FIG. 3 includes display of the pupillary distance PD and the vertex distance VD as positional information of the eyeglass lens. The pupillary distance PD is referred for determining a lens center with respect to an eyeglass frame. The vertex distance VD is referred for obtaining the simulation information for correction.

<Simulation Report>

The simulation report is mainly configured with simulation information.

The simulation report may include the simulation information such as a simulation image of an optotype image and a predicted examination result of the subjective examination. The predicted examination result may be a prospective half-way result of the subjective examination or may be a final prospective result of a subjective prescription value.

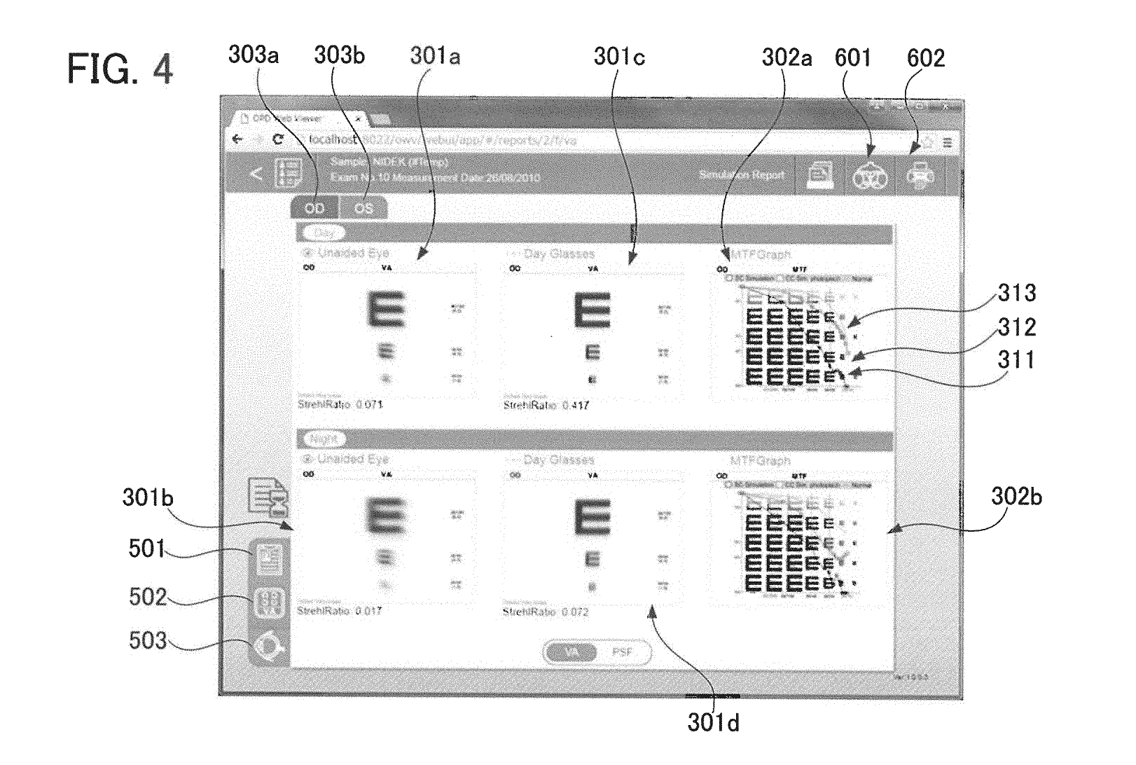

As shown in FIG. 4, the simulation report may be displayed with simulation images 301a to 301d, each illustrating an appearance of an optotype for the subjective examination. The optotype for the subjective examination may be any one of a visual acuity testing target, an astigmatic target, a target for vision screening, and others. In FIG. 4, the visual acuity testing targets are shown as the simulation images 301a to 301d. As shown in FIG. 4, the optotype for the subjective examination may be displayed with a visual acuity value corresponding to the optotype. Thus, the examiner can estimate the visual acuity of the examinee. In FIG. 4, a plurality of appearances of objects with various visual acuity values are indicated. Specifically, the appearances in predetermined three types of visual acuity values (to be more specific, 20/100, 20/40, and 20/20) are indicated in each of the simulation images 301a to 301d.

As an alternative for or as well as the optotype for the subjective examination, the simulation report may be displayed with a PSF image which is a simulation image of a point index. In an example shown in FIG. 4, choosing operation of a button (one example of widget) on the monitor 50 switches modes of displaying the optotype for the subjective examination and displaying the PSF image in the simulation report.

As shown in FIG. 4, a Strehl ratio may be indicated with the simulation images 301a to 301d in the simulation report. The Strehl ratio is introduced as the maximum intensity distribution of the PSF. The closer the Strehl ratio approaches 1, the higher a contrast sensitivity becomes with less aberration. Indication of the Strehl ratio helps the examiner and the examinee to quantitatively grasp the quality of vision.

The simulation report may display simulation information indicating vision of a naked eye (hereinafter, referred as “naked-eye simulation information”) and simulation information indicating vision in a corrected state (hereinafter, referred as “correction simulation information”) at the same time or one at a time in turns. In FIG. 4, naked-eye simulation images 301a and 301b as examples of the naked-eye simulation information and correction simulation images 301c and 301d as examples of the correction simulation information are concurrently displayed. Displaying both the naked-eye simulation information and the correction simulation information makes the examiner and the examinee easily understand improvement in vision by the eyeglass lens.

<Determining Accommodation Power of Correction Lens>

The apparatus 1 is configured to display at least the simulation information in the corrected state of a new lens (an eyeglass lens that is to be prescribed) as the correction simulation information. The configuration is not however limited to the above, and the simulation information in the corrected state of an old lens (an eyeglass lens which the examinee is wearing) may further be displayed as one component of the correction simulation information. The correction simulation information of the old lens and the correction simulation information of the new lens may be concurrently displayed or displayed one at a time in turns. Displaying both the correction simulation information of the old lens and the new lens makes the examinee confirm an improvement effect of vision of the new lens. The apparatus 1 may obtain the accommodation power of the old lens in such a manner that, for example, measurement data is transmitted from a lens meter having measured the old lens to the apparatus 1, or that a correction power may be transmitted to the apparatus 1 via an operation part.

The correction simulation information of the new lens may indicate vision in a state in which the examinee wears a lens exhibiting the maximum visual acuity. Usually, eyeglass lenses stocked in an eyeglass shop have correction powers arranged in a predetermined lens power base (for example, spherical power is arranged in 0.25 D base). Accordingly, an eyeglass lens with lens power that can perform the maximum visual acuity for the examinee's eye may be selected among a predetermined plurality of lens powers that are arranged in a predetermined lens power base (a predetermined lens power step) based on the refraction information (any one of the refraction value, distribution information of the refraction error and aberration information, for example) of the examinee's eye. The vision corrected with the selected lens power may be included in the correction simulation information of the new lens. When there are a plurality of lens powers that can exhibit the same maximum visual acuity, the lens power of the lens having the thinnest thickness may be selected from those lens powers as the lens power of an eyeglass lens to be simulated. Selection of the eyeglass lens is not limited to the above. When there are a plurality of lens powers that can provide the same maximum visual acuity, the highest lens power in plus, the lowest lens power in minus, and others may be appropriately determined among those lens powers. The correction simulation information of the new lens is not necessarily limited to the simulation in the corrected state of the lens power in the predetermined power base. As alternative, the correction simulation information may provide the vision in which the low-order aberration component of the examinee's eye has been completely corrected. Further, another alternative example is to display the corrected vision in each lens power in the predetermined lens power base and display the vision completely corrected with its low-order aberration component as the correction simulation information of the new lens at the same time or one at a time in turns.

As mentioned above, in the apparatus 1, the lens power of the new lens in the simulation is automatically set according to the results of aberration measurement by the optometry device. The thus automatically set values may be changed its lens power of the new lens by the examiner's operation. Input of any lens power and input of instruction to increase or decrease the lens power in the predetermined lens power base via the operation part may reflect a new value for the lens power of the new lens in the simulation. Furthermore, the simulation information may be renewed based on the new value.

The following explanation is given on condition that the correction wavefront aberration data of the examinee's eye is calculated based on the naked-eye wavefront aberration information assuming prescription of a correction lens having any one of the corrected lens powers, and further that the correction simulation information is obtained by processing the correction wavefront aberration data. A more detailed arithmetic method of calculating the correction wavefront aberration data is, for example, described in International Application Publication of WO2013/151171 filed by the present applicant.

In the simulation report of FIG. 4, graphs 302a and 302b indicating contrast visual acuity are displayed as one example of the simulation information. The contrast visual acuity may be introduced by an MTF (modulation transfer function). The MTF is an absolute value of an OTF (optical transfer function) that is obtained by Fourier transfer of the PSF. The contrast visual acuity in the naked-eye state is introduced by the MTF based on the naked-eye wavefront aberration data, and the contrast visual acuity in the corrected state is introduced by the MTF based on the corrected wavefront aberration data.

The graphs 302a and 302b may be indicated with visual acuity values in each contrast intensity. For example, as shown in FIG. 4, any one of a vertical axis and a horizontal axis may represent contrast, and the other one may represent the visual acuity value.

Each of the graphs 302a and 302b concurrently displays data 311 indicating the contrast visual acuity of the examinee's eye in the naked state, data 312 indicating the contrast visual acuity in the corrected state, and data 313 indicating the contrast visual acuity of normal vision. The data 313 indicating the contrast visual acuity of the normal vision represents a reference value based on measurement results of the contrast visual acuity of the examinee that has been measured several times in advance. To be more specific, in FIG. 4, the data indicating the contrast visual acuity of the normal vision is introduced from measurement results of tests conducted for examinees belonging to a certain generation and having the refraction error of less than the predetermined lens power (for example, less than 0.5 D).

Each data 311, 312, and 313 in FIG. 4 is illustrated in a form of polygonal line chart.

These three types of data 311, 312, and 313 are all displayed in one graph. Each of the data 311 indicating the contrast visual acuity of the examinee's eye in the naked state and the data 312 indicating the contrast visual acuity in the corrected state makes the examiner and the examinee easily understand the visual acuity in every contrast intensity both in the naked state and in the corrected state. Each data is further compared with the data 313 indicating the contrast visual acuity of the normal vision. This comparison is for example, useful in proposing prescription of a lens (such as a color lens) having a function of improving contrast from the examiner to the examinee. When the contrast visual acuity is low, opacity in an optic medium and abnormality or decline in visual function such as deterioration in retina function or the like are assumed. Accordingly, the examiner and the examinee can easily understand presence or absence of suspicion in abnormality or decline in the visual function from the graphs 302a and 302b.

In FIG. 4, the visual acuity values corresponding to the optotypes indicated as the simulation images 301a to 301d are emphatically indicated in the graphs 302a and 302b. Specifically, in the graphs 302a and 302b, three points of the visual acuity values of 20/100, 20/40, and 20/20 are indicated with vertical lines, so that the subject visual acuity values are emphasized.

The data 312 indicating the contrast visual acuity in the corrected state in each of the graphs 302a and 302b in FIG. 4 is simulated by use of the correction lens power in the above-mentioned predetermined lens power base. Simulation of the contrast visual acuity is performed assuming a case of correcting a lens which has been stocked in an eyeglass shop, and thus the examiner can further preferably propose a lens having a function of improving the contrast.

In FIG. 4, the simulation images 301a to 301d and the graphs 302a and 302b both in the daytime and the nighttime are displayed at the same time. When there is a large difference between the simulation information in the daytime and the simulation information in the nighttime each of which indicates the vision at the time of prescribing the correction lens (for daytime use), the examiner and the examinee can easily understand that two types of eyeglasses for the daytime use and the nighttime use need to be prescribed.

Each of the simulation images 301a to 301d and the graphs 302a and 302b in FIG. 4 are all determined their correction lens powers based on the information related to refraction of the entire examinee's eye in the daytime and introduced by use of the thus determined correction lens powers. In other words, the images and the graphs each indicate the simulation information at the time of wearing the correction lens for the daytime use. However, the indication is not limited to this, and the simulation information at the time of wearing the correction lens for the nighttime use may be indicated in the simulation report. Displaying the simulation information at the time of wearing the correction lens for the nighttime use makes the examiner and the examinee easily understand the meaning of prescribing a lens for the nighttime use.

The simulation information (specifically, any one of the simulation image and the graph) at the time of wearing the correction lens for the nighttime use is determined its correction lens power based on the information related to refraction of the entire examinee's eye in the nighttime and introduced by use of the thus determined correction lens power. The simulation information at the time of wearing the daytime-use correction lens and the simulation information at the time of wearing the nighttime-use correction lens may be displayed at the same time or one at a time in turns.

The contrast value corresponding to an estimated wearing situation of the new lens may be emphatically displayed on the graphs 302a and 302b. By these graphs 302a and 302b, the examiner and the examinee can confirm the visual acuity value (the contrast visual acuity) in the corrected state with the contrast corresponding to the wearing situation estimated for the new lens.

For example, when driving a vehicle in the nighttime is assumed as the wearing situation of the new lens, the contrast value between obstacles on a road or pedestrians and a background in the nighttime may be emphatically displayed on any one of the graphs 302a and 302b (for example, it is more preferable to display on the graph 302b which indicates the contrast visual acuity in the nighttime). Accordingly, the examiner and the examinee can confirm visibility of obstacles or the like when driving a vehicle in the nighttime.

The wearing situation of the new lens may be selected among a plurality of wearing situations prepared in advance based on input operation to the operation part 35. As a result of selection, the predetermined contrast value with respect to the selected wearing situation is emphatically indicated on the graphs 302a and 302b.

In the simulation report of FIG. 4, the simulation information of each eye is switched to be displayed according to operation of left and right switching buttons 303a and 303b. Switching operation is however not limited to this, and the simulation information of both eyes may by displayed at the same time.

<Eye Diagram Image Report>

An eye diagram image report is configured with an ocular model image 401 and both or any one of information related to the examinee's eye characteristics and the simulation information. At least a part of the information related to the examinee's eye characteristics and the simulation information is displayed in association with the ocular model image 401.

A configuration of associating the ocular model image 401 to the examinee's eye characteristics information and the simulation information (hereinafter, summarized and referred as an “ocular optical system information and others” for convenience) is now explained in detail. For example, the ocular optical system information and others correlated to each ocular part is approximated or superimposed to be placed in each ocular part on the ocular model image 401, so that the ocular optical system information and others and the ocular model image 401 are associated to each other. The ocular optical system information and others correlated to one ocular part may be information indicating any one of a measurement result, a photographed result, and imaging on the subject ocular part.

Further, symbols (such as lines, arrows, and text balloons) indicating association of the ocular optical system information and others with the corresponding part may be used. Furthermore, when a selection operation on any part on the ocular model image 401 is given by a pointing device or the like, the correspondence may be emphatically indicated by displaying the selected part and the corresponding ocular optical system information and others (for example, by enlarged indication, flashing indication, pop-up indication, and others).

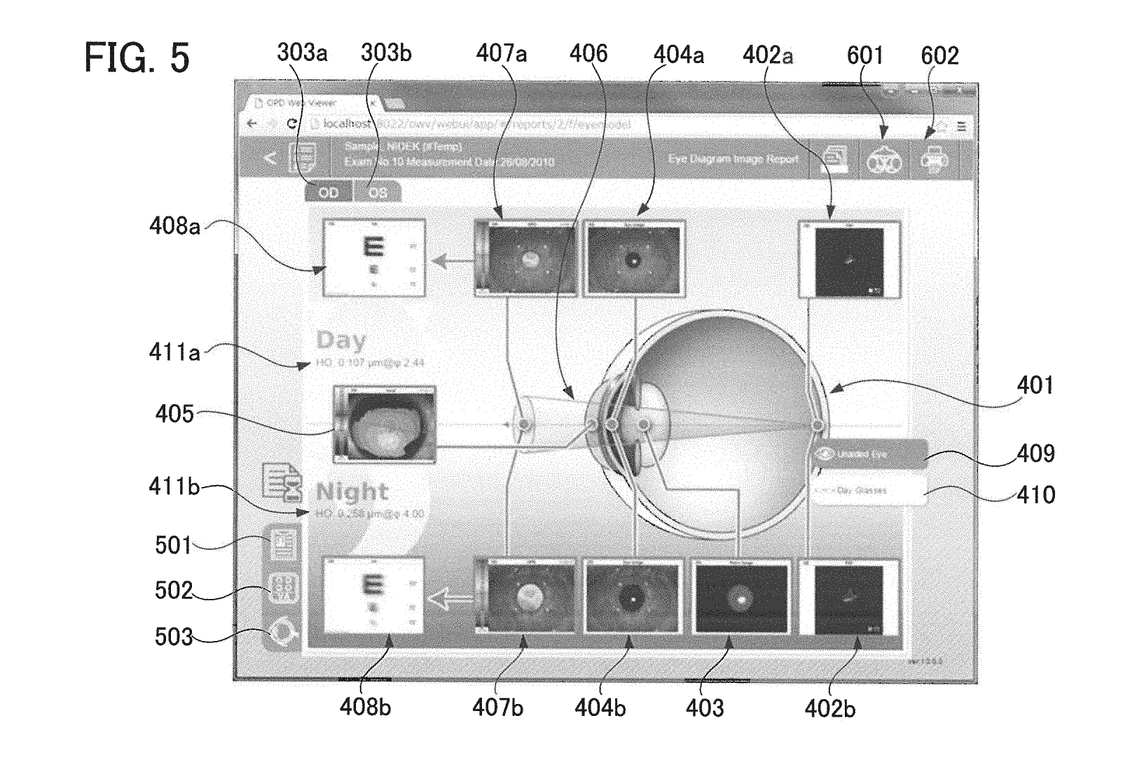

Specifically, the ocular model image 401 of the eye diagram image report in FIG. 5 includes each corresponding indication of a fundus associated with PSF images 402a and 402b each indicating imaging of a point image on the fundus, indication of a crystalline lens associated with a transillumination image 403 as a photographed image mainly showing opacity of the lens, indication of the anterior segment associated with anterior segment front reflection images 404a and 404b, and the cornea associated with a corneal curvature map 405. Further in FIG. 5, a conical-shaped graphic 406 indicating a light flux reflected on the fundus and introduced outside of the eye is depicted on the ocular model image 401. This graphic 406 corresponds to an entire light transmission body of the examinee's eye. For example, a wavefront of the fundus reflection light can be easily noticed by the examiner and others from a bottom surface part (or a section) of a conical shape outside the eye. As shown in FIG. 5, this type of graphic 406 may be associated with the refractivity distribution maps 407a and 407b, for example.

Further, in FIG. 5, the graphic 406 is associated with simulation images 408a and 408b indicating the appearances of optotypes for the subjective examination via the refractivity distribution maps 407a and 407b. Thus, the examinee can intuitively understand the relationship of the vision of the examinee and the refractivity distribution.

The above-mentioned corresponding display of the ocular optical system information and the ocular model image helps the examiner to explain to the examinee the meaning of the ocular optical system information and the simulation information that are unfamiliar to the examinee.

In FIG. 5, among various information displayed on the screen, the information changing between the daytime and the nighttime are concurrently displayed by the value (data) in the daytime and the value (data) in the nighttime. To be specific, each of the PSF images 402a and 402b, the anterior segment front surface reflection images 404a and 404b, the refractivity distribution maps 407a and 407b, and the simulation images 408a and 408b of the optotype for the subjective examination concurrently displays data in the daytime and the nighttime. Accordingly, differences in a state of each part of the eye and differences in the appearances in the daytime and the nighttime are easily compared and explained.

The simulation information indicated in the eye diagram image report includes the naked-eye simulation information and the correction simulation information displayed at the same time or displayed one at a time in turns. In an example of FIG. 5, any one of a naked-eye simulation selection button 409 and a correction simulation selection button 410 displayed on the monitor 50 is configured to be chosen to switch and display the selected simulation information.

Further in FIG. 5, numerical values representing the high-order aberration components are displayed in association with the simulation information. When the numerical value is large, the examiner can easily explain to the examinee that the examinee's eye is hard to have an effect of correction based on the numerical result. In FIG. 5, both the numerical value in the daytime and the numerical value in the nighttime are displayed. Accordingly, when the difference between the numerical value in the daytime and the nighttime is large, the examiner can easily explain to the examinee that the aberration on a side around the cornea or the crystalline lens is large and thus the vision in the nighttime is hardly improved.

<Method of Switching Each Report>

The report displayed on the monitor 50 may be switchable from one report which is selectively displayed to another report. Switching the display may be performed based on one selection operation (for example, one-time click or one-time tap on a tab or a button on the monitor 50) for the widget (such as a button, a tab, and an icon) on the monitor 50. To be specific, in the present example, first to third report selection tabs 501, 502, and 503, each corresponding to the three reports are displayed with all the reports on the monitor 50. The selection operation of choosing any one of the tabs is input to display the report corresponding to the thus chosen tab on the monitor 50. In the present example, the first tab 501 corresponds to the basic information report, the second tab 502 corresponds to the simulation report, and the third tab 503 corresponds to the eye diagram image report, respectively.

In the present example, the selection operation of the tabs 501, 502, or 503 is acceptable in any reports, and one unit of selection operation switches one report to another one corresponding to the selected tab. The one unit of selection operation means the minimum operation required for selecting the widget such as one-time click of a mouse, one-time tap on a touch screen or the like.

Each tab 501 to 503 is displayed with an icon symbolized with each report corresponding to the subject tab. The icons are formed by symbolizing particular graphic image of each report. The second tab 502 is, for example, provided with an icon symbolized with a simulation image of an optotype for the subjective examination which is displayed only in the simulation report. The third tab 503 is provided with an icon symbolized with an ocular model image which is displayed only in the eye diagram image report. Further, the first tab 501 is provided with an icon made to look like a clinical chart so that the basic information report is easily known as a report directed to the examiner.

An order of arranging the tabs 501 to 503 may be switchable as appropriate by operating the operation part. For example, the examiner chooses any one of the tabs 501 to 503 via a pointing device and drags the thus chosen tab in an up and down direction, so that an arrangement order according to the dragging operation is set. Further, rearrangement of the tabs to be in the order of the examiner's or the examinee's reading enables easy reading of each report and easy explanation by the examiner to the examinee.

<Data Output>

In the present example, by selection of a first output button 601 or a second output button 602, both of which are displayed in each report, the data is output from the apparatus 1.

The first output button 601 is selected to transmit the data to the subjective examination device. The first button 601 is displayed with an icon made to look like the subjective examination device (a refractor). In the present example, when the first button 601 is selected, at least the WF refraction value is transmitted to the subjective examination device from the apparatus 1. Not only the WF refraction value, the simulation information such as simulation images may be transmitted when the first button 601 is selected. Further, the data transmitted to the subjective examination device based on operation of the first button 601 may be any one of the data in the daytime and the data in the nighttime. The examiner may choose any one of the data to be transmitted.

The second output button 602 is selected to print each report.

As mentioned above, the apparatus 1 selectively displays three types of reports, “the basic information report,” “the simulation report,” and “the eye diagram image report” on the monitor 50. The basic information report is summarized with various information used for lens prescription, and thus the examiner uses this report to perform the subjective examination and to determine a prescription value of a new lens. The simulation report is summarized with the simulation report at least including the simulation image indicating the examinee's vision in the corrected state. This report thus makes the examiner and the examinee understand the examinee's vision in the corrected state corrected by the new lens. The eye diagram image report provides at least a part of the information included in the basic information report, in which the information giving an influence on the vision in the corrected simulation image is displayed as corresponding to each part of the ocular model image. Accordingly, when a clear simulation image as the corrected simulation image cannot be indicated in the simulation report, the examiner can easily explain the examinee the reason (ocular optical system information) of causing such a problem. The three types of reports displayed by the apparatus 1 can thus appropriately indicate the effects of the new lens to the examinee and is useful for the examiner to prescribe the new lens.

A detailed explanation is given as above according to the embodiment, but the present disclosure is not limited to the above embodiment and may be modified in various manner.

For example, in the above embodiment, three reports of the basic information report, the simulation report, and the eye diagram image report are selectively displayed, but the display is not limited to this.

For example, the two reports of the basic information report and the eye diagram image report may be provided and selectively displayed. In this case, the eye diagram image report also takes a role of the simulation report of the above embodiment, and thus the eye diagram image report preferably includes the correction simulation information. The eye diagram image report further preferably includes display of at least a part of the information related to the examinee's eye characteristics, which has influence on the vision provided by the correction simulation information, and the displayed information is associated with each ocular part of the ocular model image. This modified example provides less number of reports, and thus preferable prescription of the correction lens is performed. Accordingly, in this modified example, the number of widgets for selecting (switching) the report to be displayed is also reduced to two types according to the number of the reports.

The simulation information includes various kinds of information as mentioned in the above embodiment, and the report including various simulation information tends to be complicated in its screen arrangement. However, the report of the present embodiment is displayed independently (displayed as a different report from the basic information report and the eye diagram image report), thus enabling easy understanding of each report.

Further alternatively, simulation information of generating “fogging” in the correction lens may be displayed as the simulation information indicating the vision of the examinee's eye in the corrected state. The simulation calculation is carried out in consideration with a predetermined aberration corresponding to a level of the simulated “fogging” in order to obtain the simulation information when the “fogging” is generated.

What is claimed is:

1. A method of generating information for assisting lens prescription, the method including:
an obtention step in which a computer obtains
information related to examinee's eye characteristics including refraction information about refraction of an entire examinee's eye, and
correction simulation information, which is generated at least based on the refraction information, indicating vision of the examinee's eye assuming a correction lens prescription; and
a display control step of generating
a first report summarized with information related to the examinee's eye characteristics and used for the correction lens prescription,
a second report at least including the correction simulation information, and
a third report including an ocular model image and at least a part of the information related to the examinee's eye characteristics having influence on the vision in the correction simulation information, the part of the information being displayed associated with each ocular part in the ocular model image,
the display control step controlling the computer to selectively display at least any one of the reports on a monitor.

2. The method of generating information for assisting lens prescription according to claim 1, wherein
the obtention step further includes a step of controlling the computer to obtain information related to the examinee's eye characteristics both in daytime and nighttime and the correction simulation information,
the display control step further includes a step of controlling the computer to display the information related to the examinee's eye characteristics or the correction simulation information both in the daytime and the nighttime in each one of the first report, the second report, and the third report.

3. The method of generating information for assisting lens prescription according to claim 2, wherein the display control step further includes a step of controlling the computer to display differential information different from the information in the daytime as refraction information of the examinee's eye in the nighttime in the first report.

4. The method of generating information for assisting lens prescription according to claim 1, wherein the display control step further includes a step of controlling the computer to generate and display a graphic image of a plurality of visual acuity testing targets which are different in visual acuity values as correction simulation information in the second report.

5. The method of generating information for assisting lens prescription according to claim 1, wherein the display control step further includes a step of controlling the computer to display contrast visual acuity information indicating a predicted value of a contrast visual acuity of the examinee's eye in a corrected state with the correction simulation information.

6. The method of generating information for assisting lens prescription according to claim 1, wherein
the method further includes a correction power changing step of controlling the computer to change a correction lens power assumed in the correction simulation information according to operation of an operation part, and
the obtention step further includes a step of reflecting the correction lens power that has been changed in the correction power changing step at least in the correction simulation report of the second report.

7. The method of generating information for assisting lens prescription according to claim 1, wherein
the correction lens is an eyeglass lens,
the obtention step further includes a step of controlling the computer to obtain positional information related to a position where the eyeglass lens is placed with respect to the examinee's eye, and
the display control step further includes a step of controlling the computer to display the positional information in the first report.

8. The method of generating information for assisting lens prescription according to claim 1, wherein
the display control step further includes a step of controlling the computer to provide three types of widgets each corresponding to the first report, the second report, and the third report and display the widget with the selected report, and
the computer is configured to switch display to the report corresponding to the selected widget upon receipt of selection instruction selecting any one of the three types of the widgets.

9. A method of generating information for assisting lens prescription, the method including:
an obtention step in which a computer obtains
information related to examinee's eye characteristics including refraction information about refraction of an entire examinee's eye, and
correction simulation information, which is generated at least based on the refraction information, indicating vision of the examinee's eye assuming a correction lens prescription; and
a display control step of generating
a first report summarized with the information related to the examinee's eye characteristics and used for the correction lens prescription, and
a third report including the correction simulation information and an ocular model image, the third report being generated and displayed with at least a part of the information related to the examinee's eye characteristics having influence on vision in the correction simulation information, the part of the information being associated with each ocular part in the ocular model image,
the display control step controlling the computer to selectively display at least any one of the reports on a monitor.

10. The method of generating information for assisting lens prescription according to claim 9, wherein
the obtention step further includes a step of controlling the computer to obtain information related to the examinee's eye characteristics both in daytime and nighttime and the correction simulation information,
the display control step further includes a step of controlling the computer to display the information related to the examinee's eye characteristics or the correction simulation information both in the daytime and the nighttime in each of the first report and the third report.

11. The method of generating information for assisting lens prescription according to claim 10, wherein the display control step further includes a step of controlling the computer to display differential information different from the information in the daytime as refraction information of the examinee's eye in the nighttime in the first report.

12. The method of generating information for assisting lens prescription according to claim 9, wherein the display control step further includes a step of controlling the computer to display contrast visual acuity information indicating a predicted value of a contrast visual acuity of the examinee's eye in a corrected state with the correction simulation information in the third report.

13. The method of generating information for assisting lens prescription according to claim 9, wherein
the method further includes a correction power changing step of controlling the computer to change a correction lens power assumed in the correction simulation information according to operation of an operation part, and
the obtention step further includes a step of reflecting the correction lens power that has been changed in the correction power changing step at least in the correction simulation report of the third report.

14. The method of generating information for assisting lens prescription according to claim 9, wherein
the correction lens is an eyeglass lens,
the obtention step further includes a step of controlling the computer to obtain positional information related to a position where the eyeglass lens is placed with respect to the examinee's eye, and
the display control step further includes a step of controlling the computer to display the positional information in the first report.

15. The method of generating information for assisting lens prescription according to claim 9, wherein
the display control step further includes a step of controlling the computer to provide two types of widgets each corresponding to the first report and the third report and display the widget with the selected report, and
the computer is configured to switch display to the report corresponding to the selected widget upon receipt of selection instruction selecting one of the two types of the widgets.
